(19) United States
(12) Patent Application Publication
(10) Pub. No.: US 2026/0070016 A1
(43) Pub. Date: Mar. 12, 2026

(54) HEAT EXCHANGING CATALYST BLOCK

(71) Applicant: ExxonMobil Technology and Engineering Company, Spring, TX (US)

(72) Inventors: Christopher K. MORGAN, Spring, TX (US); Lin ZHAO, Spring, TX (US); William J. PAYNE, Spring, TX (US)

(21) Appl. No.: 19/293,597

(22) Filed: Aug. 7, 2025

Related U.S. Application Data
(60) Provisional application No. 63/692,881, filed on Sep. 10, 2024.

(51) Int. Cl. B01D 53/34; B01D 53/94

(52) U.S. Cl. CPC B01D 53/343; B01D 53/944; B01D 2255/9155; B01D 2257/7025; B01D 2258/018

(57) ABSTRACT

An exemplary apparatus includes an inlet tube for receiving and distributing a first gas mixture, an outlet tube for collecting and discharging a treated gas mixture, inlet channels in fluid communication with the inlet tube each receiving a portion of the first gas mixture distributed from the inlet tube, and outlet channels in fluid communication with the outlet tube each supplying a portion of the treated gas mixture to the outlet tube. Each of the inlet channels is separated from an adjacent outlet channel by a metal partition wall facilitating heat exchange. The apparatus includes a catalyst block including incoming channels each in fluid communication with an inlet channel at one end of the incoming channel and outgoing channels each in fluid communication with an outlet channel at one end of the outgoing channel, and a common channel in fluid communication with the inlet channel and the outgoing channel.

### CROSS-REFERENCE TO RELATED APPLICATION

This application claims priority to and the benefit of U.S. Provisional Application No. 63/692,881, entitled “HEAT EXCHANGING CATALYST BLOCK,” having a filing date of Sep. 10, 2024, the disclosure of which is incorporated herein by reference in its entirety.

### FIELD

The present disclosure generally relates to internal combustion engine exhaust gas treatment. More specifically, the present disclosure is directed towards reducing hydrocarbon, particularly methane, present in natural gas internal combustion engine exhaust gas.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Compressor stations are widely used in unconventional hydrocarbon management. For example, unconventional hydrocarbon management may include hydraulic fracturing, among other activities that may include the use of compression. In various examples, each of any number of compressor stations located in a hydrocarbon field may include a number of engines at each location. For example, each location may have three to six compressor engines. These compressor engines may use natural gas as an energy source during operation.

In various examples, such compressor engines may include two-stroke or four-stroke engines. The relatively cold temperatures of the exhaust streams produced by these engines are significantly lower than the required methane effective reduction temperatures for palladium and/or platinum catalysts. In addition, at the relatively low exhaust temperature range of these combustion sources palladium catalysts tend to be vulnerable to deactivation caused by exposure to sulfur in the combustion exhausts from many gaseous fuels.

Lean-burn four-stroke gas engines, which typically burn natural gas, are commonly used for energy production, and numerous industrial and agricultural purposes. For example, four-stroke gas engines are used for natural gas compression, distributed and/or backup electrical generation. Two-stroke lean-burn gas engines, which also typically burn natural gas, are commonly used for natural gas compression. The temperature of the exhaust stream leaving a lean-burn four-stroke gas engine will typically only be in the range of from about 700° F. to about 850° F. The temperature of the exhaust stream leaving a two-stroke lean-burn engine will be even lower, typically only in the range of from about 400° F. to about 500° F. Typically, an exhaust gas oxidation catalyst is positioned downstream of the engine such that heat losses in the exhaust pipe cause the catalyst operating temperature to be even lower.

At these low temperatures, even a large quantity of fresh palladium and/or platinum catalyst material, which is quite costly, may not be effective for oxidizing the methane emissions contained in the exhaust streams. For a lean-burn four-stroke engine at an exhaust temperature of 700° F. and a low gas hourly space velocity (GHSV) through the catalyst of 45,000 (i.e., ±10%) hr⁻¹, the amount of the methane removed from the exhaust stream by a combination palladium and platinum catalyst material will typically be less than 10%. Moreover, the situation for two-stroke lean-burn gas engines is even more difficult. As compared with four-stroke lean-burn gas engines, two-stroke lean-burn engines tend to allow more fuel to pass through the cylinders unburned. The result may be higher exhaust emissions of hydrocarbons, including methane.

### SUMMARY

One aspect of the disclosure provides an apparatus for treating a first gas mixture to produce a treated gas mixture. The apparatus includes an inlet tube for receiving and distributing the first gas mixture. The apparatus also includes an outlet tube for collecting and discharging the treated gas mixture. The apparatus further includes a plurality of inlet channels in fluid communication with the inlet tube each receiving a portion of the first gas mixture distributed from the inlet tube. The apparatus also further includes a plurality of outlet channels in fluid communication with the outlet tube each supplying a portion of the treated gas mixture to the outlet tube, wherein each of the inlet channels is separated from an adjacent outlet channel by a metal partition wall facilitating heat exchange. The apparatus includes a catalyst block including a plurality of incoming channels each in fluid communication with an inlet channel at one end of the incoming channel and a plurality of outgoing channels each in fluid communication with an outlet channel at one end of the outgoing channel. The apparatus also includes a common channel in fluid communication with another end of each of the inlet channel and another end of the outgoing channel.

Another aspect of the disclosure provides a method for treating a feed gas mixture to produce a treated gas mixture. The method includes flowing the feed gas mixture in an inlet channel in a first direction. The method also includes feeding the feed gas mixture from the inlet channel into an incoming channel present in a catalyst block having a catalyst disposed on the surface or inside of the incoming channel. The method further includes flowing the feed gas mixture inside the incoming channel in a second direction and reacting the feed gas mixture on contacting the catalyst to release thermal energy to produce a first gas mixture exiting the incoming channel. The method also further includes flowing the first gas mixture in an outgoing channel present in the catalyst block and obtaining a second gas mixture exiting the outgoing channel, wherein the second gas mixture has a temperature higher than the feed gas mixture. The method also includes flowing the second gas mixture in an outlet channel in a direction opposite to the first direction. The method further includes exchanging heat between the second gas mixture with the feed gas mixture via a partitioning wall between the inlet channel and the outlet channel to produce the treated gas mixture.

### BRIEF DESCRIPTION OF THE DRAWINGS

The advantages of the present disclosures are better understood by referring to the following detailed description and the attached drawings, in which:

FIG. 1 is an illustration of a system for catalysis of hydrocarbons in natural gas engines, according to embodiments herein;

FIG. 2A is a top view diagram of an example apparatus for catalysis of hydrocarbons, according to an embodiment;

FIG. 2B is a diagram depicting a first cross-sectional side view along a vertical cross-section cutting through a center of an inlet tube of an example apparatus for catalysis of hydrocarbons, according to an embodiment;

FIG. 2C is a diagram depicting a second cross-sectional side view along a vertical cross-section cutting through the center of an outlet tube of an example apparatus for catalysis of hydrocarbons, according to an embodiment;

FIG. 2D is a diagram of an end view of a first plate of an example apparatus for catalysis of hydrocarbons, according to an embodiment;

FIG. 2E is a diagram of an end view diagram of a second plate of an example apparatus for catalysis of hydrocarbons, according to an embodiment; and

FIG. 3 is a process flow diagram of a method for reducing hydrocarbon emissions from gas engines, according to another embodiment.

### DETAILED DESCRIPTION

As used herein, the following terms shall have the following meanings.

As used herein, the terms “example,” exemplary,” and “embodiment,” when used with reference to one or more components, features, structures, or methods according to the present disclosure, are intended to convey that the described component, feature, structure, or method is an illustrative, non-exclusive example of components, features, structures, or methods according to the present disclosure. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present disclosure.

As used herein, “effective-reduction temperature” refers to, with respect to a given compound and a given catalyst, the temperature at which effective reduction of the compound occurs by reacting with oxygen on contacting the catalyst. Thus for a given catalyst, H₂, methane, ethane, propane, and the like, may have differing effective-reduction temperature. For catalysts including a Group 10 metal such as platinum, the effective-reduction temperature of methane is typically higher than that of H₂, ethane, and propane. The effective-reduction temperature is more specifically the temperature that sustains a 50% conversion.

In the following detailed description section, specific embodiments of the present disclosure are described. However, to the extent that the following description is specific to a particular embodiment or a particular use of the present disclosure, this is intended to be for exemplary purposes only and simply provides a description of the exemplary embodiments. Accordingly, the disclosure is not limited to the specific embodiments described below, but rather, include all alternatives, modifications, and equivalents falling within the true spirit and scope of the appended claims.

Natural gas engines, even lean-burn engines, may produce an engine exhaust gas that includes residual methane at various amounts. Methane is the second most abundant anthropogenic greenhouse gas after carbon dioxide, accounting for approximately 20% global emissions. Although methane is less abundant than CO₂ in the atmosphere, methane is significantly more potent than carbon dioxide in terms of global warming potential because methane is estimated to be more than 25 times as effective as carbon dioxide at trapping heat in the atmosphere on a 100-year basis. However, reducing the emissions of hydrocarbons, such as methane, as byproducts may be both difficult and costly. For example, simple combustion of such emissions may not be possible due to the small amount released in the engine exhaust (may range from about 100 ppm to about 10,000 ppm; methane flammable limit is >50,000 ppm). An improved method for reducing unburned hydrocarbon emissions in natural gas engines is thus desirable.

Commercially available catalyst blocks can be used to effectively reduce hydrocarbons such as methane by oxidation at certain high temperatures, referred to herein as effective removal temperatures. Below the methane effective-reduction temperature (e.g., ≥500° C. for certain catalyst), the methane-reduction capability of the catalyst is insufficient. Often the temperature of the exhaust gas existing the engine (e.g., 400° C. from a natural gas engine) is significantly lower than the methane effective-reduction temperature. To effectively reduce methane in the exhaust gas using such catalyst, the exhaust gas needs to be heated. One approach to heat the exhaust gas is to inject a supplemental fuel (e.g., H₂, hydrocarbons such as ethane, propane, and the like) having a lower effective-reduction temperature than methane into the exhaust gas, allow the supplemental fuel to oxidize on contact a catalyst first to release thermal energy, thereby heating the exhaust gas and/or the catalyst to the effective-reduction temperature of methane, which in turn, results in effective removal of methane from the exhaust gas to a desired low concentration. For a single large lean burn natural gas engine (i.e., having 500+ horsepower), the cost of the supplemental fuel per year can range from US$25,000 to US$130,000. Where substantial number of natural gas engines are involved, the costs of the supplemental fuel can be significant. Therefore, there is a strong desire to reduce the amount of promoter fuel consumed.

One method to reduce the amount of supplemental fuel consumption is to use the hot exhaust gas exiting the catalyst block upon methane reduction (which can have a temperature of, e.g., ≥650° C.) to heat the exhaust gas exiting the engine (which can have a temperature of, ≤450° C.) by using a separate air-to-air heat exchanger located upstream of the methane-removing catalyst block. However, such a solution is relatively expensive. In addition, the size of stand-alone heat exchangers may add bulk to already large engines employed in the field. Therefore a system that efficiently reduces methane with less consumption of a supplemental fuel and with minimal use of space and less complexity of design is desired.

Accordingly, embodiments described herein enable the efficient catalyzation of methane in natural gas engines. In one embodiment, an arrangement of a catalyst block also functions as a heat exchanger to capture the heat of reaction to heat the incoming exhaust gas up to the temperature at which a reaction in the block can be sustained for the purpose of destruction of unburned hydrocarbons, such as methane, in the exhaust gas of natural gas engines. In some embodiments, this is done by a manifold which passes the incoming exhaust gas through the block passages that are adjacent to the return gas passages. The embodiments thus create a counter-current heat exchanger functionality within the catalyst block. The embodiments thus avoid the need for additional fuel as a promoter to be added to the exhaust gas to increase the temperature and thus would be less expensive to operate and would reduce the additional carbon emissions from burning the supplemental fuel. Such an arrangement also eliminates the need for a separate large expensive heat exchanger. The embodiments thus provide a single unit that acts as both an efficient catalyzer and heat exchanger that enables this efficiency.

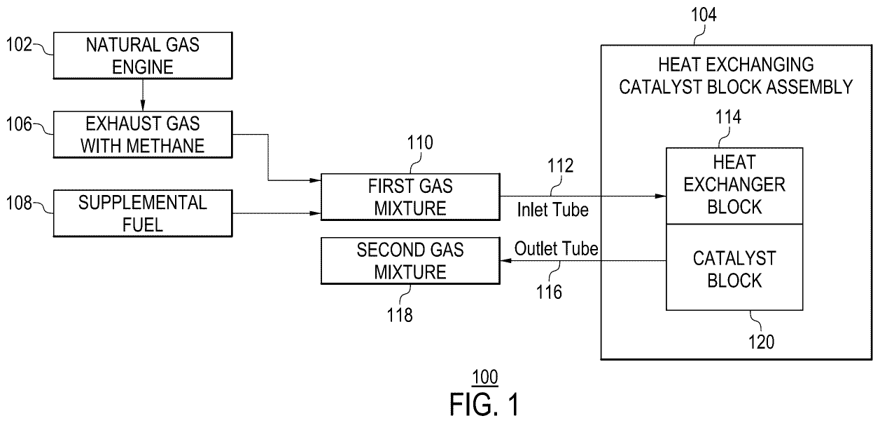

Referring now to FIG. 1, a system 100 for catalytic reduction of hydrocarbons in natural gas engines exhaust is provided. The system 100 includes a natural gas engine 102. The system 100 includes a heat exchanging catalyst assembly 104 that is coupled to the natural gas engine 102 to receive exhaust gas 106 that includes methane and oxygen. For example, the natural gas engine 102 produces the exhaust gas 106 from the combustion of natural gas during operation. The exhaust gas 106 can have a temperature T1 of e.g., from 350, 360, or 370° C., to 380, 390, or 400° C., which is lower than the methane effective-reduction temperature of the catalyst disposed on the surface of the catalyst block.

In various embodiments, where the exhaust gas 106 exiting the engine (e.g., a natural gas engine combusting natural gas as fuel) has a low concentration of methane, a supplemental fuel 108 is injected into it to form the feed gas mixture. For example, the supplemental fuel 108 may be hydrogen (H₂), ethane, propane, butanes, and the like, and mixtures thereof. For example, at the startup, the injection of supplemental fuel may be necessary. In some embodiments, once the temperature of the catalyst block reaches the effective-reduction temperature, the amount of injected supplemental fuel 108 may be reduced. In various embodiments, the supplemental fuel 108 may be injected either continuously or intermittently. In some embodiments, the supplemental fuel 108 is preferably a mixture of H₂ and propane, which have a low effective-reduction temperature. In some embodiments, the supplemental fuel 108 is preferably propane, which can be readily available in an unconventional hydrocarbon production site.

In various embodiments, the resulting feed gas mixture 110 thus includes a hydrocarbon (e.g., methane) and molecular oxygen, in addition to the supplemental fuel 108. The first gas mixture 110 is then fed into the inlet tube 112 of the heat exchanging catalyst assembly 104, where it is heated, via the heat exchanger block 114 between the incoming passage of the inlet tube 112 and adjacent return gas passage coupled to outlet tube 116, by the hotter second gas mixture 118 in the return gas passages couple to outlet tube 116, to a temperature T2, where T2>T1. The thus heated first gas mixture 110 then flows through channels in the catalyst block 120. On contacting the catalyst disposed on the surfaces in the catalyst block 120, due to the lower effective-reduction temperature of the supplemental fuel, the supplemental fuel may first react with oxygen to release a quantity thermal energy, which heats the gas mixture 110 to a temperature T3, where T3>T2, and T3 is at or above the effective-reduction temperature of methane. Methane then reacts with oxygen on contacting the catalyst block 120 to produce a second gas mixture 118, releasing additional thermal energy, further heating the second gas mixture 118 to a temperature T4, where T4>T3.

The second gas mixture 118 then flows into the return gas passages coupled to outlet tube 116, where the second gas mixture 118 exchanges heat with the first gas mixture 110 in the incoming gas passages via the heat exchanger block 114 as described above, and is cooled down to a temperature T5 on exiting the return gas passages coupled to outlet tube 116, where T5<T4. As result of catalyst oxidation in the catalyst block 120, the second gas mixture 118 exiting the return passages and the outlet tube 116 can have a reduced total concentration of molecular oxygen.

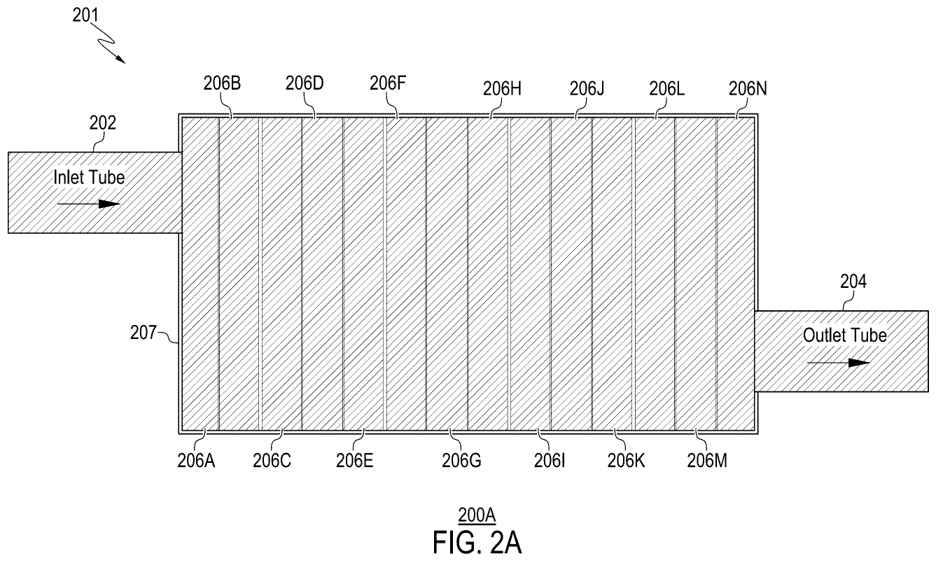

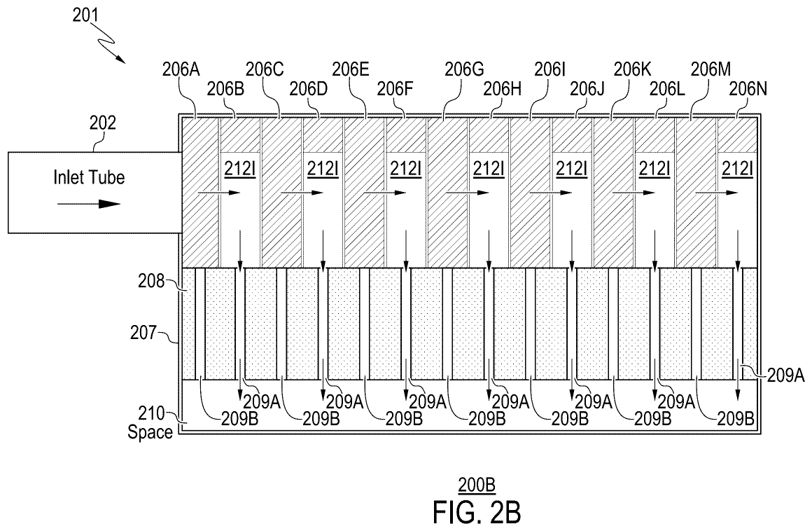

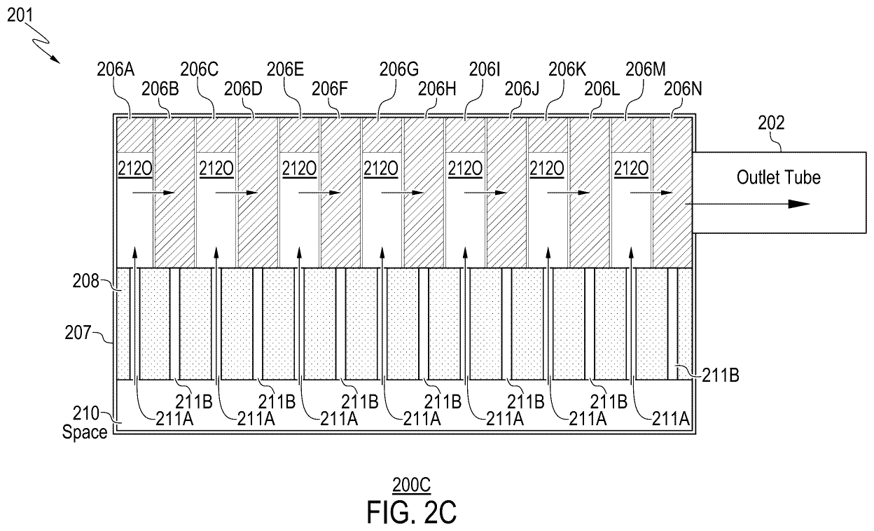

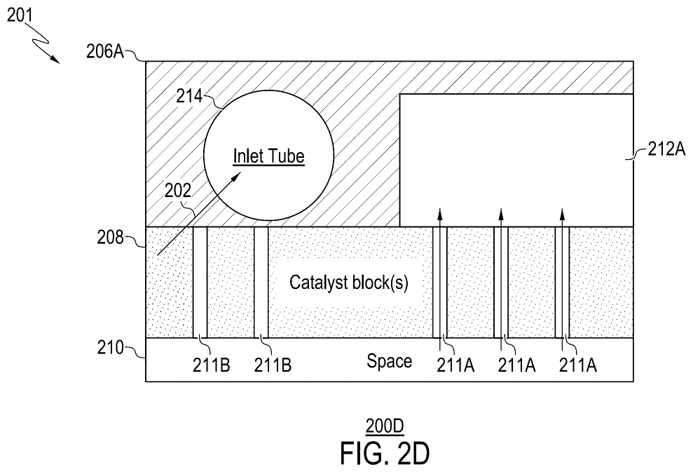

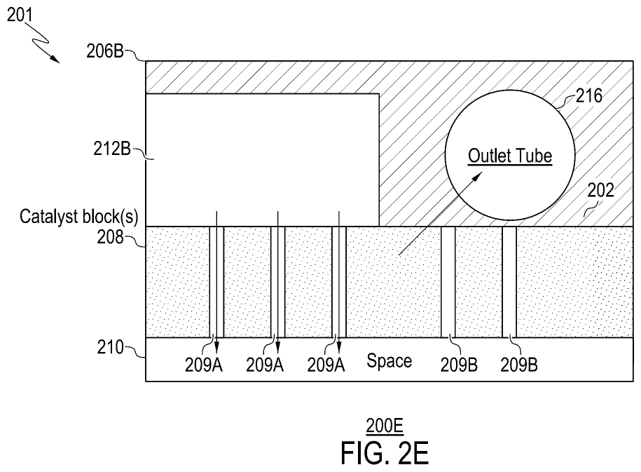

In various embodiments, the geometry of the heat exchanging catalyst assembly 104 with the linear flow passages may thus be used in a dual purpose arrangement of also having a counter-current heat exchanger functionality. In some embodiments, the heat exchanging catalyst assembly 104 includes inlet tube 112 that is adjacent to outlet tube 116 of the heat exchanging catalyst assembly 104. In some embodiments, the heat exchanger block 114 includes inlet channels and outlet channels, preferably arranged in alternating fashion, to facilitate heat exchange. In various embodiments, the inlet channels can at one end connect with an inlet tube, forming a first manifold. The outlet channels can at one end connect with an outlet tube, forming a second manifold adjacent to the first manifold. In various embodiments, the counter-current heat exchanger functionality is accomplished by manifolding the incoming first gas mixture 110 to direct flow back and forth through the heat exchanging catalyst block assembly 104 at heat exchanger block 114 such that the lower temperature incoming gas passages fluidically coupled to inlet tube 112 are adjacent to the hotter return gas passages fluidically coupled to outlet tube 116. In some embodiments, the specific method used to manifold the incoming and exiting exhaust gas may be similar to the manifolding used in the art of piping and heat exchangers. For example, the manifolds within the heat exchanger block 114 may be similar to the manifold of a plate and frame heat exchanger, or a machined or weld fabricated manifold of smaller channels. An example embodiment of such a plate heat exchanger configuration is shown in detail in FIGS. 2A-2F, but may take other forms having similar functionality. For example, the incoming gas passages coupled to inlet tube 112 may be integrated with the return gas passages coupled to the outlet tube 116 using other forms of heat exchanger designs, such as double pipe heat exchangers, shell-and-tube heat exchangers, or plate and shell heat exchangers, among other possible forms.

In various embodiments, the catalyst block 120 is preferably a honeycomb monolith having a number of channels, including incoming channels at one end thereof in fluid communication with the inlet channels in the heat exchanger and outgoing channels at one end thereof in fluid communication with the outlet channels in the heat exchanger. In some embodiments, the catalyst block 120 is preferably made of a low thermal conductivity material with a low thermal expansion. In one embodiment, the catalyst block 120 is made of a cordierite ceramic. In various embodiments, a catalyst is present on the surface or inside the incoming channels. In some embodiments, the catalyst is also preferably on the surface or inside of the outgoing channels. In some embodiments, where the catalyst block 120 is a honeycomb, a catalyst can be formed on the surfaces or inside the multiple channel walls by, for example, wash coating the surfaces, followed by drying. In various embodiments, any combination of palladium, platinum, rhodium or any other metals may be used. For example, the total amount of the combined catalyst may be in the range of from about five grams to about 120 grams per cubic foot of the oxidation catalyst. In some examples, the oxidation catalyst includes a support or substrate, a washcoat applied to the support or substrate, any combination of palladium, platinum, and rhodium on the washcoat. For example, the support or substrate can be formed of a material selected from cordierite, mullite or FeCrAlY or similar high temperature foil. In some examples, the washcoat applied to the support or substrate, can include one or more materials selected from aluminum oxide, cerium oxide, zirconium oxide, or silicon dioxide. In various examples, the palladium, provided on and/or in the washcoat in an amount in the range of from 0 grams to 132 grams per cubic foot of the oxidation catalyst. Similarly, the platinum, provided on and/or in the washcoat in an amount in the range of from 0 grams to 132 grams per cubic foot of the oxidation catalyst. In addition, the rhodium, provided on and/or in the washcoat in an amount in the range of from 0 grams to 132 grams per cubic foot of the oxidation catalyst. In one example, a total amount of platinum, palladium and rhodium may range from 4.5 grams to 132 grams per cubic foot of the oxidation catalyst. In some examples, additional components or additives that can be used in the washcoat can include lanthanum oxide, barium oxide, barium carbonate, cerium oxide, zirconium oxide and mixtures thereof. In various embodiments, a catalytic oxidation of hydrocarbons such as methane occurs on contacting of the catalyst with the hydrocarbon and oxygen.

In various embodiments, the incoming channels and the outgoing channels are sealed off from each other to prevent cross-talk between them. In various embodiments, the catalyst block 120 includes a common channel (space) that is in fluid communication with the other ends of the incoming channels and outgoing channels of the catalyst block 120, allowing the first gas mixture to exit the incoming channels and enter the outgoing channels. In some embodiments, on contacting the catalyst in the incoming channel and optionally in the outgoing channel, the hydrocarbon is oxidized, releasing thermal energy and producing second gas mixture 118 having a temperature higher than the first gas mixture 110. The optional additional oxidation in the outgoing channels may further produce a second gas mixture 118 having an even higher temperature than the first gas mixture 110.

Thus, by integrating the catalyst block 120 with the heater exchanger block 114, a compact apparatus with higher thermal efficiency in the form of heat exchanging catalyst assembly 104 is achieved. In this manner, the required supplemental fuel amount is reduced.

FIG. 2A is diagram of a top view 200A of an example apparatus 201 for catalysis of hydrocarbons, according to an embodiment. The apparatus 201 includes an inlet tube 202 and outlet tube 204 coupled together via a series of adjacent plates 206A, 206B, 206C, 206D, 206E, 206F, 206G, 206H, 206I, 206J, 206K, 206L, 206M, and 206N. For example, the adjacent plates may alternate between two designs, such the two designs described in FIGS. 2D and 2E, each having a round cut out and a rectangular cutout. In various embodiments, the round cutouts of plates 206A, 206C, 206E, 206G, 206I, 206K, and 206M are fluidically coupled to the inlet tube 202. Similarly, the round cutouts of 206B, 206D, 206F, 206H, 206J, 206L, and 206N are fluidically coupled to the outlet tube 204. In some embodiments, the adjacent plates 206A-206N are contained within a metal enclosure 207. For example, the metal enclosure 207 may have two cutouts on either side enabling pipes to be connected as inlet tube 202 and outlet tube 204. Alternatively, in some embodiments, the apparatus 201 includes end wall plates (not shown). For example, the end wall plates may similarly function to enclose plates 206A and 206N and similarly have cutouts to enable the connection of pipes as inlet tube 202 and outlet tube 204. In these embodiments, an end wall plate is adjacent to plate 206A and a second end wall plate is adjacent to plate 206N, respectively. Each of such end wall plates have no rectangular cutout, but only a round cutout connecting only to the outlet tube 204 and inlet tube 202, respectively, which also seals the rectangular cutouts of 206A and 206N from the environment outside of the apparatus 201. Alternatively, in some embodiments, both the inlet tube 202 and the outlet tube 204 can exit the same end wall plate.

As shown in FIG. 2A, an input exhaust gas may sequentially pass through the series of plates 206A-206N and be output at outlet tube 204. Although shown opposing the inlet tube 202 in FIG. 2A, in some embodiments, the outlet tube 204 may alternatively be on the same side as the inlet tube 202. For example, in some embodiments, the input exhaust gas may sequentially pass through the series of plates 206A-206N to return back to the same side and be output via an outlet tube 204 on the same side as the inlet tube 202. For example, the input exhaust gas may be untreated exhaust from a natural gas engine. The output gas may be a treated gas. For example, the treated gas may have a reduced amount of unburned hydrocarbons, such as methane. In the embodiments of FIGS. 2A-2F, the input gas is treated via a catalyst block beneath the series of series of plates 206A-206N, as shown and discussed further detail with respect to FIGS. 2B-2F. In various embodiments, the outer shell of the apparatus 201 shown in FIG. 2A is insulated to prevent heat transfer.

FIG. 2B is a diagram of a first cross-sectional side view 200B along a vertical cross-section cutting through a center of an inlet tube 202 of the example apparatus 201 for catalysis of hydrocarbons, according to an embodiment. The side view 200B of FIG. 2B is more specifically a bifurcating cross-sectional view facing the inlet side as shown in FIGS. 2D, 2E, and 2F. The side view 200B of FIG. 2B focuses on the inlet flow of the apparatus 201. Diagonal shading indicates solid parts of the apparatus 201, while solid white portions indicate spaces in which gas is allowed to freely flow. In particular, the rectangular cutouts of plates 206B, 206D, 206F, 206H, 206J, 206L, and 206N, in fluid communication with the round cutouts of 206A, 206C, 206E, 206G, 206I, 206K, 206M, and with inlet tube 202, form inlet channels 212I, in which the first gas mixture flows downward toward and into the incoming channels in the catalyst blocks 208. In some embodiments, in which end plates are used, a round cutout of the second end wall plate adjacent to 206N is also in fluid communication with the rectangular cutouts of plates 206B, 206D, 206F, 206H, 206J, 206L, and 206N and the round cutouts of plates 206A, 206C, 206E, 206G, 206I, 206K, 206M, and inlet tube 202 to form inlet channels 212I.

As shown in FIG. 2B, in one embodiment, after passing through plate 206A, incoming untreated exhaust gas is preheated via plate 206B and then sent down into one or more catalyst blocks 208 via a set of incoming channels 209A. A set of dummy channels 209B are not in fluid communication with the inlet channels 212I. Hot partially treated gas from the catalyst blocks 208 is then received at plate 206C and sent into plate 206D to be further sent back into the catalyst blocks 208. In various embodiments, this process may repeat in alternating fashion, as shown with arrows. For example, plates 206F, 206H, 206J, 206L, and 206N similarly receive, preheat, and send the exhaust gas back into the catalyst blocks 208 for further catalysis. In various embodiments, the catalyst block 208 include incoming channels and outgoing channels that are separate from each other and have opposite gas flow directions. After passing through the catalyst blocks 208 the gas flows into the space 210, where the incoming gases are allowed to freely mix together and reenter the catalyst blocks 208. For example, the space 210 is a common channel in which gases are allowed to mix. In various embodiments, the space 210 is defined by a bottom plate, four side wall plates, and the bottom of the catalyst blocks 208.

In various embodiments, the plates 206A, 206B, 206C, 206D, 206E, 206F, 206G, 206H, 206I, 206J, 206K, 206L, 206M, and 206N have alternating designs enabling incoming gas to flow adjacent to outgoing exhaust gas. In some embodiments, the specific example alternating designs be those described with respect to FIGS. 2D and 2E. In various embodiments, the plates 206A, 206B, 206C, 206D, 206E, 206F, 206G, 206H, 206I, 206J, 206K, 206L, 206M, and 206N are constructed from any suitable metals. For example, the metal may be steel, aluminum, copper, or any other suitable metal that efficiently conducts heat. In some embodiments, the plates may be made from sheet metal that is cut and stamped to produce alternating plate designs, such as the two plate designs shown and described in FIGS. 2D and 2E.

In various embodiments, the one or more catalyst blocks 208 are made of thin sheets of metal represented by dotted shading. In one embodiment, the thin sheets of metal are approximately 0.002 inches or 0.0508 millimeters thick. In various embodiments, the sheets of metal are stacked in a corrugated pattern, much like cardboard. In various embodiment, the catalyst blocks 208 may be any type of catalyst that uses a conservation or increase in temperature for methane oxidation. In some embodiments, the catalyst is a precious metal catalyst made of any suitable metal such as palladium, platinum, rhodium, etc. In various embodiments, the catalyst blocks 208 have a structured geometry creates linear passages through the block for which the exhaust gas to be treated can flow and come in close communication with the catalyst on the walls.

FIG. 2C is a diagram of a second cross-sectional side view 200C along a vertical cross-section cutting through the center of an outlet tube 204 of the example apparatus 201 for catalysis of hydrocarbons, according to an embodiment. The side view 200C of FIG. 2C is more specifically a cross-sectional view facing inwards from just inside the outer frame of the apparatus 201 as shown in FIGS. 2D, 2E, and 2F. The side view 200C of FIG. 2C accordingly focuses on the outlet flow of the apparatus 201. For example, the rectangular cutouts of plates 206A, 206C, 206E, 206G, 206I, 206K, and 206M, in fluid communication with the round cutouts of 206B, 206D, 206F, 206H, 206J, 206L, and 206N, and to outlet tube 204, form the outlet channels 212O, which receive treated gas mixture exiting the outgoing channels 211A in the catalyst blocks 208, which flows upwards and collects into the outlet tube 204 before exiting the apparatus 201. A set of dummy channels 211B are not in fluid communication with outlet channels 212O. In some embodiments, in which end plates are used, the round cutout of the end wall plate adjacent to plate 206A, is also in fluid communication with the rectangular cutouts of plates 206A, 206C, 206E, 206G, 206I, 206K, and 206M, and the round cutouts of 206B, 206D, 206F, 206H, 206J, 206L, and 206N, and the outlet tube 204 to form the outlet channels 212O.

As shown in FIG. 2C, in one embodiment, after passing through one or more of the catalyst blocks 208, incoming exhaust gas enters into plates 206A, 206C, 206E, 206G, 206I, 206K, and 206M before returning back into the catalyst blocks 208 as described in FIG. 2B, and ultimately passes out of the outlet tube 204. The heat from the returning exhaust gas thereby increases the temperature of the adjacent incoming exhaust gas. In some embodiments, a reduced amount of promoter fuel may be added as needed to maintain a target temperature at the catalyst blocks 208. The alternating direction of the currents of the plates 206A-206N thus create a counter-current heat exchanger functionality within the catalyst blocks 208. For example, the counter-current may be found at the top and the bottom of the catalyst blocks 208. In this manner, the incoming exhaust gas is efficiently preheated without using significant additional fuel or burners. Thus, the apparatus 201 enables more efficient catalysis of methane that uses reduced amounts of promoter fuel.

FIG. 2D is a diagram of an end view 200D of a first plate 206A of the example apparatus 201 for catalysis of hydrocarbons. As shown in FIGS. 2B and 2C, the first plate 206A may be duplicated to form plates 206C, 206E, 206G, 206I, 206K, and 206M.

As shown in FIG. 2D, the first plate 206A includes an inlet cutout 214 configured to receive exhaust gas from inlet tube 202. In addition, the first plate 206A includes a rectangular catalyst cutout 212 that receives treated exhaust gas from the catalyst blocks 208. In various embodiments, the gas from the catalyst blocks may have a higher temperature than the incoming exhaust gas at the inlet cutout 214.

FIG. 2E is a diagram of end view 200E of a second plate 206B of the example apparatus 201 for catalysis of hydrocarbons. As shown in FIGS. 2B and 2C, the second plate 206B may be duplicated to form plates 206D, 206F, 206H, 206J, 206L, and 206N.

As shown in FIG. 2E, the second plate 206B includes an outlet tube 216 configured to receive treated exhaust gas from the catalyst blocks 208. In addition, the second plate 206B includes a rectangular catalyst cutout forming an outlet channel 212A that receives incoming exhaust gas to be sent back into the catalyst blocks 208. In various embodiments, the catalyst block 208 are formed in a honeycomb, with outgoing channels 211A and dummy channels 211B evenly distributed through the honeycomb structure. The outgoing channels 211A are in fluid communication with outlet channel 212A and outlet tube (not shown). In various embodiments, the exhaust gas from the catalyst blocks 208 may have a higher temperature than the incoming exhaust gas, and heats the adjacent plate to increase or maintain the temperature of the incoming exhaust gas.

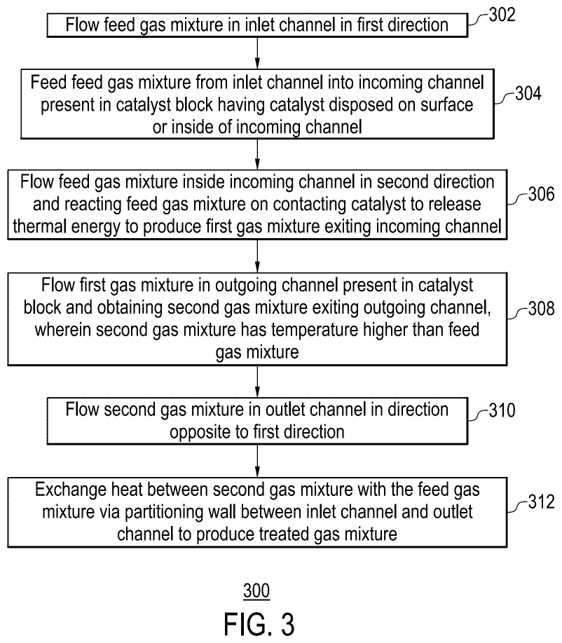

FIG. 3 is a process flow diagram of a method 300 for reducing hydrocarbon emissions from gas engines. In various examples, the method 300 may be implemented using the apparatus 201 of FIGS. 2A-2E and in the apparatus 100 of FIG. 1.

At block 302, a feed gas mixture flows in an inlet channel in a first direction. For example, the feed gas mixture may include an exhaust gas is received from a natural gas engine. As one example, the natural gas engine is a gas engine in a compressor station. For example, the exhaust gas is generated via the combustion of natural gas in the natural gas engine. In various embodiments, the exhaust gas includes any number of unburned hydrocarbons and molecular oxygen. In one embodiment, the unburned hydrocarbons include methane. In various embodiments, the inlet channel is at an inlet of an integrated heat exchanger and catalyzer. In some embodiments, the received exhaust gas has a temperature of 750 degrees F, or 400 degrees C. In various embodiments, the exhaust gas is mixed with a supplemental fuel to produce a first gas mixture prior to being received at an inlet of an integrated heat exchanger and catalyzer. For example, the supplemental fuel may include hydrogen, and/or hydrocarbons such as methane, ethane, propane, butane, or any combination thereof. In various embodiments, the supplemental fuel is added continuously or intermittently. For example, the supplemental fuel may be added at a startup of the engine and reduced thereafter.

At block 304, the feed gas mixture from the inlet channel is fed into an incoming channel present in a catalyst block having a catalyst disposed on the surface or inside of the incoming channel. In some embodiments, the catalyst block is constructed using a low thermal conductivity material with a low thermal expansion. For example, the catalyst block may be made of cordierite ceramic. In various embodiments, the catalyst disposed on the surface or inside of the incoming channel may be any suitable precious metal catalyst, such as palladium or platinum, among other suitable metals.

At block 306, the feed gas mixture flows inside the incoming channel in a second direction and the feed gas mixture reacts on contacting the catalyst to release thermal energy to produce a first gas mixture exiting the incoming channel. In various embodiments, the feed gas mixture is treated via the catalyst at a target temperature to remove unburned hydrocarbons. In various embodiments, the catalyst is configured to catalyze a specific unburned hydrocarbon at a target temperature. In various embodiments, treating the exhaust gas includes passing the gas through a catalyst at the target temperature. For example, the target temperature may be an effective reduction temperature for the catalyst. In various embodiments, on contacting the catalyst in the incoming channel, the hydrocarbon is oxidized, releasing thermal energy and producing the first gas mixture having a temperature higher than the feed gas mixture.

At block 308, the first gas mixture flows in an outgoing channel present in the catalyst block and a second gas mixture exiting the outgoing channel is obtained. The second gas mixture has a temperature higher than the feed gas mixture. In various embodiments, on contacting the catalyst in the outgoing channel, the hydrocarbon is oxidized, releasing thermal energy and producing the second gas mixture having a temperature higher than the first gas mixture.

At block 310, the second gas mixture flows in an outlet channel in a direction opposite to the first direction. For example, the second gas mixture may flow in a direction opposite to the direction of the feed gas mixture.

At block 312, heat is exchanged between the second gas mixture with the feed gas mixture via a partitioning wall between the inlet channel and the outlet channel to produce the treated gas mixture. In various embodiments, the exhaust gas is preheated to a target temperature. For example, the target temperature is an effective-reduction temperature for a catalyst configured to catalyze one or more hydrocarbons in the exhaust gas. In some embodiments, the target temperature may depend on the hydrocarbon to be catalyzed. In one embodiment, for the catalysis of methane, the target temperature may be 950 degrees Fahrenheit (F) or 510 degrees centigrade (C). Thus, the method 300 enables incoming exhaust gas to be efficiently preheated to a target temperature that allows one or more hydrocarbons such as methane to be effectively catalyzed via oxidation at the target temperature. For example, the amount of supplemental fuel used may be reduced. In various embodiments, the treated gas mixture is then output into the environment.

While the present disclosure may be susceptible to various modifications and alternative forms, the embodiments discussed above have been shown only by way of example. However, it should again be understood that the disclosure is not intended to be limited to the particular embodiments disclosed herein. Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated. All numerical values within the detailed description herein are modified by “about” the indicated value, and take into account experimental error and variations that would be expected by a person having ordinary skill in the art. Indeed, the present disclosure include all alternatives, modifications, and equivalents falling within the true spirit and scope of the appended claims.

What is claimed is:

1. An apparatus for treating a first gas mixture to produce a treated gas mixture, the apparatus comprising:
an inlet tube for receiving and distributing the first gas mixture;
an outlet tube for collecting and discharging the treated gas mixture;
a plurality of inlet channels in fluid communication with the inlet tube each receiving a portion of the first gas mixture distributed from the inlet tube;
a plurality of outlet channels in fluid communication with the outlet tube each supplying a portion of the treated gas mixture to the outlet tube, wherein each of the inlet channels is separated from an adjacent outlet channel by a metal partition wall facilitating heat exchange;
a catalyst block comprising a plurality of incoming channels each in fluid communication with an inlet channel at one end of the incoming channel and a plurality of outgoing channels each in fluid communication with an outlet channel at one end of the outgoing channel; and
a common channel in fluid communication with another end of each of the inlet channel and another end of the outgoing channel.

2. The apparatus of claim 1, comprising a plurality of alternating adjacent plates through which the inlet channels and the adjacent outlet channels are formed.

3. The apparatus of claim 2, wherein the plurality of alternating adjacent plates comprise a set of plates that include an inlet cutout to receive incoming exhaust gas and a catalyst cutout to receive outgoing treated exhaust gas.

4. The apparatus of claim 3, wherein the inlet cutout is circular and the catalyst cutout is rectangular.

5. The apparatus of claim 2, wherein the plurality of alternating adjacent plates comprise a set of plates that include an outlet cutout to receive outgoing treated exhaust gas and a catalyst cutout to emit incoming exhaust gas to the catalyst block.

6. The apparatus of claim 1, wherein the catalyst block is positioned below and adjacent to a manifold comprising the plurality of inlet channels and the plurality of outlet channels.

7. The apparatus of claim 1, wherein the common channel comprises a space below the catalyst block to receive from and send the incoming exhaust gas back through the catalyst block.

8. The apparatus of claim 1, wherein the target temperature comprises an effective-reduction temperature for the hydrocarbon.

9. The apparatus of claim 1, wherein the target temperature is at least 510 degrees centigrade.

10. The apparatus of claim 1, wherein the catalyst block comprises a low thermal conductivity material with a low thermal expansion.

11. The apparatus of claim 1, wherein the catalyst block comprises a honeycomb monolith.

12. The apparatus of claim 1, wherein the hydrocarbon comprises methane.

13. The apparatus of claim 1, wherein the temperature of the treated gas mixture is higher than the temperature of the first gas mixture.

14. The apparatus of claim 1, wherein the catalyst block comprises a catalyst on a surface or inside of the incoming channels of the catalyst block.

15. The apparatus of claim 1, the catalyst block comprises a catalyst on a surface or inside of the outgoing channels of the catalyst block.

16. A method for treating a feed gas mixture to produce a treated gas mixture, the method comprising:
flowing the feed gas mixture in an inlet channel in a first direction;
feeding the feed gas mixture from the inlet channel into an incoming channel present in a catalyst block having a catalyst disposed on the surface or inside of the incoming channel;
flowing the feed gas mixture inside the incoming channel in a second direction and reacting the feed gas mixture on contacting the catalyst to release thermal energy to produce a first gas mixture exiting the incoming channel;
flowing the first gas mixture in an outgoing channel present in the catalyst block and obtaining a second gas mixture exiting the outgoing channel, wherein the second gas mixture has a temperature higher than the feed gas mixture;
flowing the second gas mixture in an outlet channel in a direction opposite to the first direction; and
exchanging heat between the second gas mixture in the outlet channel with the feed gas mixture via a partitioning wall between the inlet channel and the outlet channel to produce the treated gas mixture.

17. The method of claim 16, comprising mixing an exhaust gas from an engine with a supplemental fuel to produce the feed gas mixture.

18. The method of claim 17, wherein the supplemental fuel comprises propane.

19. The method of claim 17, wherein the supplemental fuel comprises hydrogen.

20. The method of claim 16, wherein the supplemental fuel is added intermittently.

21. The method of claim 16, wherein the supplemental fuel is added continuously.

22. The method of claim 16, wherein the supplemental fuel is added at a startup of a natural gas engine.

23. The method of claim 16, wherein reacting the feed gas mixture comprises passing the feed gas mixture through the catalyst at a target temperature.

24. The method of claim 23, wherein the target temperature comprises an effective-reduction temperature of the catalyst.

25. The method of claim 16, wherein the feed gas mixture comprises methane.

26. The method of claim 16, wherein an exhaust gas in the feed gas mixture comprises exhaust generated from a combustion of a natural gas engine.
